(19) United States
(12) Patent Application Publication
(10) Pub. No.: US 2007/0144253 A1
(43) Pub. Date: Jun. 28, 2007

(54) Liquid surface detection device

(75) Inventor: Kazuhisa Kobayashi, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/526,665

(22) Filed: Sep. 26, 2006

(30) Foreign Application Priority Data
Sep. 26, 2005 (JP) 2005-277823
Sep. 21, 2006 (JP) 2006-255272

(51) Int. Cl. G01F 23/26; G01B 7/14; G01N 1/14; G01N 35/10

(52) U.S. Cl. 73/304 C; 324/662; 73/864.24

(57) ABSTRACT

A liquid surface detector is constituted of an oscillator that outputs an alternating current signal at a frequency of 130 kHz, and a modulator circuit for modulating the alternating current signal with a capacitance index signal that indicates a change in capacitance. The capacitance changes with movement of a suction probe relative to a cup containing a liquid. An output signal of the modulator is filtered and amplified by a first filtering circuit that passes a frequency component of 130 kHz through it. Through a wave detector circuit and a second filtering circuit that passes a frequency component of 2 kHz, a signal corresponding to the capacitance index signal is detected from an output of the first filtering circuit, and is compared with a reference signal, to detect that the probe gets into contact with the liquid surface.

### FIELD OF THE INVENTION

The present invention relates to a liquid surface detection device, which measures capacitance in order to judge whether a tip of a suction probe of an automatic analyzer or the like touches a surface of a liquid to suck, or not.

### BACKGROUND OF THE INVENTION

In a conventional automatic analyzer, a suction probe is used to suck a small amount of liquid, such as reagent, specimen and diluent, from a cup, and inject it into another cup. If the tip of the suction probe is put deeply into the liquid to suck, the amount of the liquid adhering to the periphery of the probe becomes so much that it causes contamination, dropping or dispersing of the liquid from the probe in motion, or inexactness of the injection amount from the probe. In order to avoid such troubles, many conventional automatic analyzers are provided with a device for detecting accurately whether the tip of the suction probe comes into contact with the liquid surface, to stop excessive insertion of the probe tip into the liquid. For example, European Patent Publication No. 0164679 and Japanese Laid-open Patent Application Nos. Hei 6-213699 and Hei 6-241862 disclose devices that judge based on a change in capacitance whether a suction probe is in contact with a liquid surface or not.

In European Patent Publication No. 0164679, a change in capacitance between the probe and a liquid cup holder is utilized to detect the surface of the liquid in the cup. In Japanese Laid-open Patent Application No. Hei 6-213699, a high resistance is interconnected between an electric signal supplier and the probe, to tap out signals from opposite terminals of the high resistance. After regulating the tapped signals, a liquid surface is detected based on a change in waveform of the regulated signals. The device disclosed in Japanese Laid-open Patent Application No. Hei 6-241862 is provided with an electrode connected to a signal source, and a signal-receiving electrode. The received signal is subjected to a differentiation process, and a subsequent output signal is used for detecting the liquid surface.

The above-mentioned prior arts, however, involve a problem that detection errors are caused by external noises more frequently at higher sensitivity of detection.

### SUMMARY OF THE INVENTION

In view of the foregoing, a primary object of the present invention is to provide a liquid surface detection device that can improve the detection sensitivity while preventing occurrence of errors due to external noises.

A liquid surface detection device of the present invention comprises an oscillator oscillating at a first frequency to output an alternating current signal; a modulator circuit including a conductive member that is movable up and down relative to a surface of a liquid, such as a probe, the modulator circuit modulating the alternating current signal from the oscillator with a capacitance index signal indicating a change in capacitance that is caused by the movement of the conductive member relative to the liquid surface; a first filtering circuit for filtering an output signal of the modulator, to pass a frequency component having the first frequency through it; a wave detector circuit for detecting a signal from an output of the first filtering circuit; a second filtering circuit for filtering the signal output from the wave detector circuit, to pass a frequency component having a second frequency through it, the second frequency being a frequency of the capacitance index signal; and a comparator for comparing an output signal of the second filtering circuit with a reference signal to detect that the conductive member gets into contact with the liquid surface.

The first frequency of the oscillator is preferably not less than 50 times the second frequency of the capacitance index signal. The first frequency of the oscillator is preferably set at 100 kHz to 2000 kHz.

According to a preferred embodiment, the liquid surface detection device further comprises a second comparator for comparing the output signal of the second filtering circuit with a second reference signal to detect that the conductive member removes off the liquid surface.

Because of the filtering circuits, the influence of noises on the signals is suppressed, and the detection sensitivity is improved by raising the amplification rates of the filtering circuits without increasing the risk of detection errors.

Setting the frequency of the oscillator not less than 50 times the frequency of the capacitance index signal permits amplifying only one frequency component separately from the other, so it becomes possible to detect the liquid surface at a high accuracy while suppressing detection errors, even while there is a noise tuned in to a power source frequency or a high frequency noise. Setting the frequency of the oscillator at 100 kHz to 2000 kHz suppresses occurrence of electromagnetic interference waves. Moreover, setting the frequency of the oscillator at least 400 kHz makes the liquid surface detection device more protective against noises caused by ultrasonic equipments.

### BRIEF DESCRIPTION OF THE DRAWINGS

The above and other objects and advantages of the present invention will be more apparent from the following detailed description of the preferred embodiments when read in connection with the accompanied drawings, wherein like reference numerals designate like or corresponding parts throughout the several views, and wherein:

FIG. 1 is a schematic perspective diagram illustrating a liquid supplier using a liquid surface detection device according to an embodiment of the present invention;

FIG. 2 is a flow chart illustrating a sequence of liquid sucking process of the liquid supplier;

FIG. 3 is a block diagram illustrating the circuitry of the liquid surface detection device;

FIG. 4 shows timing charts of electric signals of the liquid surface detection device; and

FIG. 5 is a schematic diagram illustrating a liquid supplier using a liquid as a pressure medium, according to another embodiment of the present invention.

### DESCRIPTION OF THE PREFERRED EMBODIMENTS

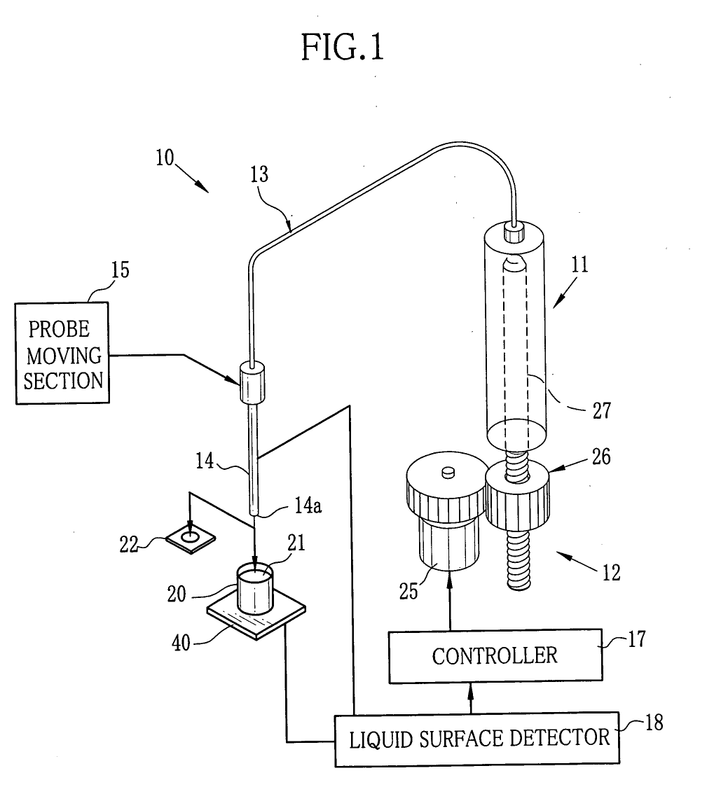

As shown in FIG. 1, a liquid supplier 10 is constituted of a syringe pump 11, a pump driver 12, an air tube 13, a suction probe 14, a probe moving section 15, a controller 17 and a liquid surface detector 18. The controller 17 controls the respective components based on a liquid surface detection signal from the liquid surface detector 18, to suck a liquid 21 from a sampling cup 20, which contains the liquid 21 as a specimen, into the suction probe 14, and then drop the sucked liquid 21 onto a test chip 22. A disposable tip member may be detachably attached to the suction probe 14, so as to change the tip member for one specimen from another.

The suction probe 14 is made of an electrically conductive material, and is set in the liquid supplier 10 with its tip 14a oriented downward and its upper end joined to one end of the air tube 13. Another end of the air tube 13 is connected to the syringe pump 11. The pump driver 12 drives the syringe pump 11. The pump driver 12 consists of a motor 25, a lead screw mechanism 26 for converting rotational movement of the motor 25 to reciprocating movement of a plunger of the syringe pump 11. Forward and backward rotation of the motor 25 causes the plunger 27 to move back and forth, so the suction probe 14 sucks and discharges the liquid 21. Instead of the lead screw mechanism 26, another mechanism for converting the rotation of the motor 25 into the reciprocation of the plunger 27, such as a ball-screw mechanism or a rack and pinion, is usable.

The probe moving section 15 is provided with a vertical motion unit and a horizontal motion unit, though they are not shown in the drawings. With these units, the probe moving section 15 moves the suction probe 14 horizontally and vertically between the sampling cup 20 and the test chip 22, so as to put the probe tip 14a into the liquid 21 in the sampling cup 20 on sucking the liquid 21, and thereafter bring the suction probe 14 to a position for discharging the liquid 21 toward the test chip 22.

The liquid supplier 10 is incorporated into a biochemical analyzer or the like that is used in a medical institute, a laboratory or the like. The biochemical analyzer detects densities of materials contained in a specimen, by fixing a spot of the specimen on a test chip, such as a dry analysis element or a dry electrolyte slide that is called a dry ion selection electrode film, and subjecting the test chip to a colorimetry process or a potentiometry process.

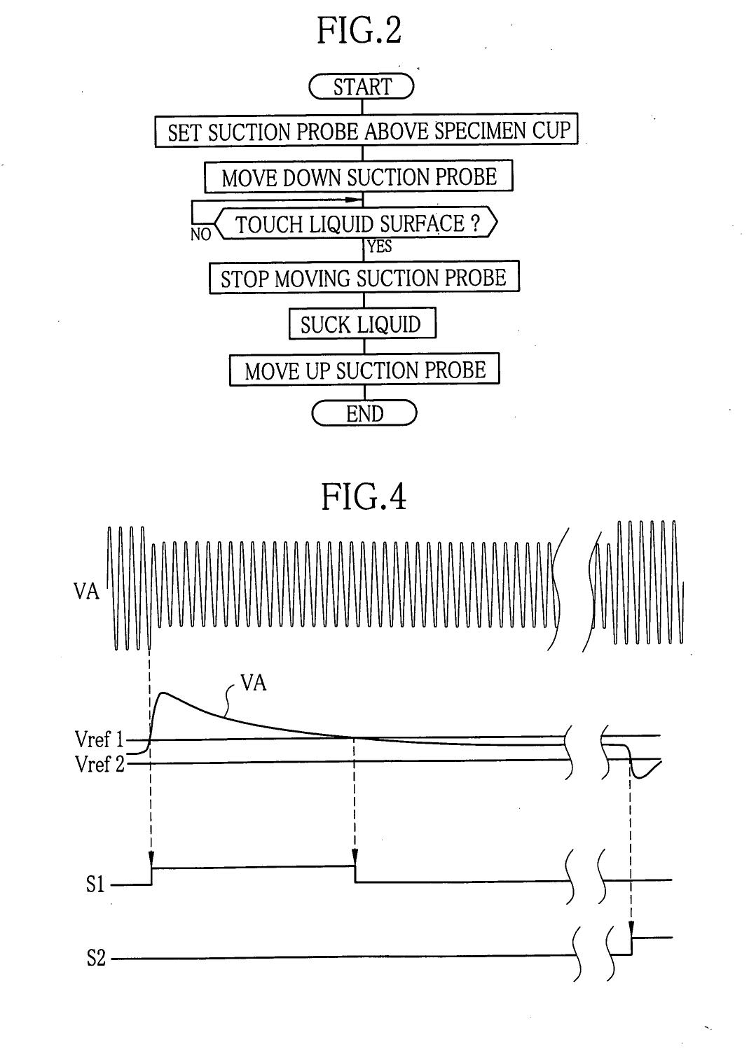

The controller 17 controls the motor 25 of the pump driver 12 and the probe moving section 15 based on the liquid surface detection signal from the liquid surface detector 18, to suck and discharge the liquid 21. As shown in the flow chart of FIG. 2, the suction probe 14 is first set at a position above the sampling cup 20. Next the suction probe 14 is moved down while the liquid surface detector 18 is checking if the tip 14a of the suction probe 14 gets into contact with the liquid surface. When the probe tip 14a reaches the liquid surface, the liquid surface detector 18 outputs the liquid surface detection signal, upon which the controller 17 controls the probe moving section 15 to stop the suction probe 14 at a position where the probe tip 14a is inserted slightly in the liquid 21. The depth of insertion of the probe tip 14a in the liquid 21 is adjusted to a requisite minimum value, so that the liquid adhering to the periphery of the suction probe 14 hardly causes contamination, unexpected liquid dropping and error in the liquid supply amount.

While dipping the probe tip 14a in the liquid 21, the syringe pump 11 is driven to suck the liquid 21 into the suction probe 14. After the liquid 21 is sucked by a predetermined amount, the probe moving section 15 moves the suction probe 14 up to a position allowing the horizontal movement of the suction probe 14. Then the suction probe 14 is moved horizontally to a position above the test chip 22, and then moved down to the discharging position where the liquid 21 is discharged as a droplet from the suction probe 14 onto the test chip 22. Note that it is possible to dispense the liquid 21 from the suction probe 14 onto a plural number of test chips.

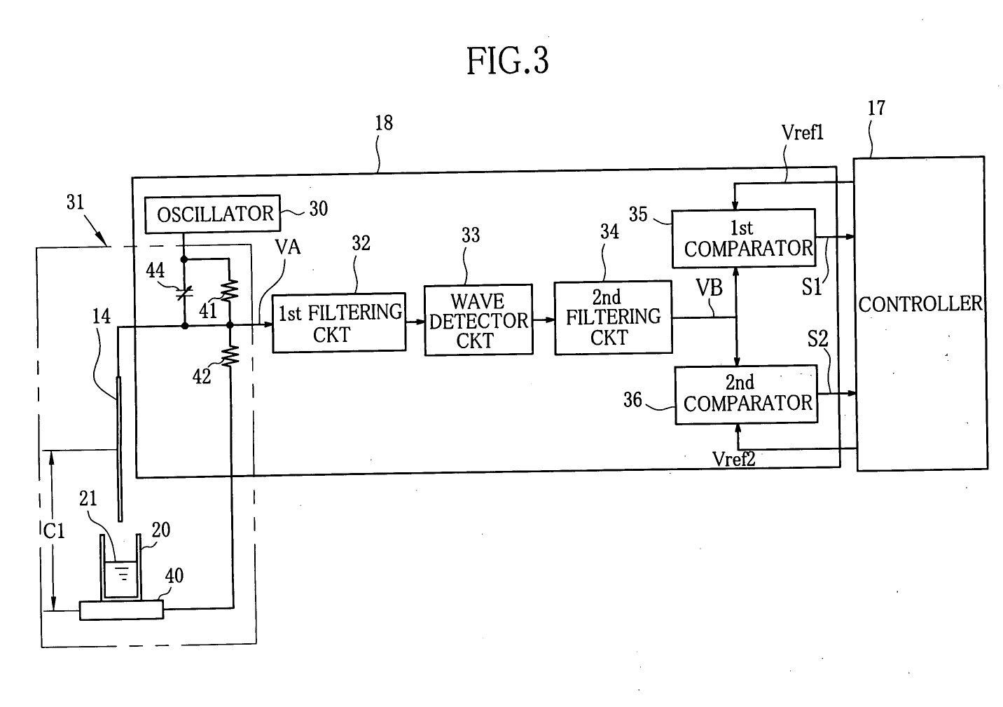

As shown in FIG. 3, the liquid surface detector 18 consists of an oscillator 30, a modulator circuit 31, a first filtering circuit 32, a wave detector circuit 33, a second filtering circuit 34 and first and second comparators 35 and 36.

The oscillator 30 consists of a sinusoidal oscillator oscillating at 130 kHz. The modulator circuit 31 modulates an alternating current signal from the oscillator 30 with a capacitance index signal that represents a change in capacitance C1 between the suction probe 14 and a referential grounding surface 40 that is provided by a housing of the apparatus. For this purpose, the alternating current signal is voltage-divided by use of a couple of resistors 41 and 42 having a resistance of 1 M ohm, the capacitance C1 between the suction probe 14 and the referential grounding surface 40, and a trimmer capacitor 44. The trimmer capacitor 44 is adjustable to have the same capacitance as the capacitance C1. The capacitance C1 varies depending upon the vertical position of the suction probe 14 to the liquid surface in the sampling cup 20, and the capacitance index signal is representative of the capacitance C1, so the alternating current signal is modulated in the way as shown by VA in FIG. 4.

The first filtering circuit 32 consists of a band-pass filter that passes an alternating current signal of 130 kHz through it, and amplifies a frequency component of 130 kHz.

The wave detector circuit 33 takes out the capacitance index signal from the output of the first filtering circuit 32. The output of the wave detector circuit 33 is sent to the second filtering circuit 34. The second filtering circuit 34 consists of a band-pass filter that passes an alternating current signal of 2 kHz through it, and amplifies a frequency component of 2 kHz, as shown by VB in FIG. 4. The capacitance index signal is set to have a frequency of 2 kHz, so the output VB of the second filtering circuit 34 corresponds to the capacitance index signal.

The first comparator 35 compares the output VB of the second filtering circuit 34 with a first reference voltage signal Vref1. When the output VB is higher than the first reference voltage signal Vref1, the first comparator 35 outputs a signal S1 that indicates that the probe tip 14a touches the liquid surface. The second comparator 36 is for detecting that the probe tip 14a moves off the liquid 21. The second comparator 36 compares the output VB of the second filtering circuit 34 with a second reference voltage signal Vref2. When the output VB gets less than the second reference voltage signal Vref2, the second comparator 36 outputs a signal S2 that indicates that the probe tip 14a is moved off the liquid surface. The second comparator 36 is not always necessary but may be provided according to the need.

The signal S1 indicating that the probe tip 14a gets into contact with the liquid surface is sent from the first comparator 35 to the controller 17. Then, the controller 17 controls the probe moving section 15 to stop the downward movement of the suction probe 14 and, thereafter, starts driving the pump driver 12 to suck the liquid 21 into the suction probe 14. During the suction of the liquid 21, the probe moving section 15 is driven to restart moving the suction probe 14 downward at a speed corresponding to the lowering liquid surface of the liquid 21 as resulted from the suction. Thereby, the probe tip 14a is kept dipped by the minimum depth in the liquid 21, so the influence of the liquid adhering to the periphery of the suction probe 14 is almost entirely eliminated. Based on the signal S2 from the second comparator 36, the controller 17 can check if the suction of the liquid 21 is properly carried out.

Although the first filtering circuit 32 amplifies the alternating current signal VA at the oscillation frequency 130 kHz of the oscillator 30 in the above embodiment, it is alternatively possible to use a tuning circuit that consists of a variable capacitance diode and other elements. In that case, the tuning circuit preferably has a resonance frequency that is adjustable based on a signal from the controller 17, so as to amplify a selected frequency component of the alternating current signal. Instead of adjusting the resonance frequency based on a program in the controller 17, it is possible to adjust the resonance frequency in a frequency adjusting circuit that is provided separately from the tuning circuit.

After having the liquid 21 sucked therein, the suction probe 14 is moved to the position above the test chip 22 that is placed in an assay position, to drop the liquid 21 by a predetermined amount onto the test chip 22. Then, a not-shown chip inspector sensor of the biochemical analyzer optically measures the test chip 22, and a subsequent photometric signal is sent to the controller 17. Based on the photometric signal, the controller 17 carries out a designated biochemical analysis with reference to previously memorized correlations between the photometric signal and the material densities.

In the biochemical analysis, it is general to use as the test chip 22 a dry analysis element or an electrolyte slide that is called a dry ion selection electrode film. The dry analysis element is used for quantitative analysis in the colorimetry, whereas the electrolyte slide is used for quantitative analysis in the potentiometry. Just by dropping a specimen on the dry analysis element or the electrolyte slide, quantitative analysis of a specific chemical or formed component as contained in the specimen is available.

In the biochemical analysis using the colorimetry, the dry analysis element having a specimen dropped thereon is kept in a constant temperature for a predetermined time in an incubator, to get a color reaction (pigment producing reaction) of the specimen. Thereafter, the dry analysis element is illuminated with a photometric light including a predetermined wavelength component, to measure optical density. From the measured optical density are derived densities of biochemical materials. In the biochemical analyzer using the potentiometry, on the other hand, a pair of dry ion selecting electrodes of the same type are brought into contact with a spot of the specimen as dropped on an electrolyte slide. Then, the active amount of a designated ion is analyzed quantitatively in the potentiometry, to detect material densities.

Although the above-described embodiment sucks a specimen as the liquid 21 from the sampling cup 20 and drops it on the test chip 22, the liquid 21 may be a reagent, water or diluent. The present invention is not limited to the case where a single liquid is sucked and dropped, but also applicable to a case where different kinds of liquids, such as a specimen and a reagent, or a diluent and a specimen, are seriatim sucked into a suction probe, to mix these liquids inside a channel of the suction probe.

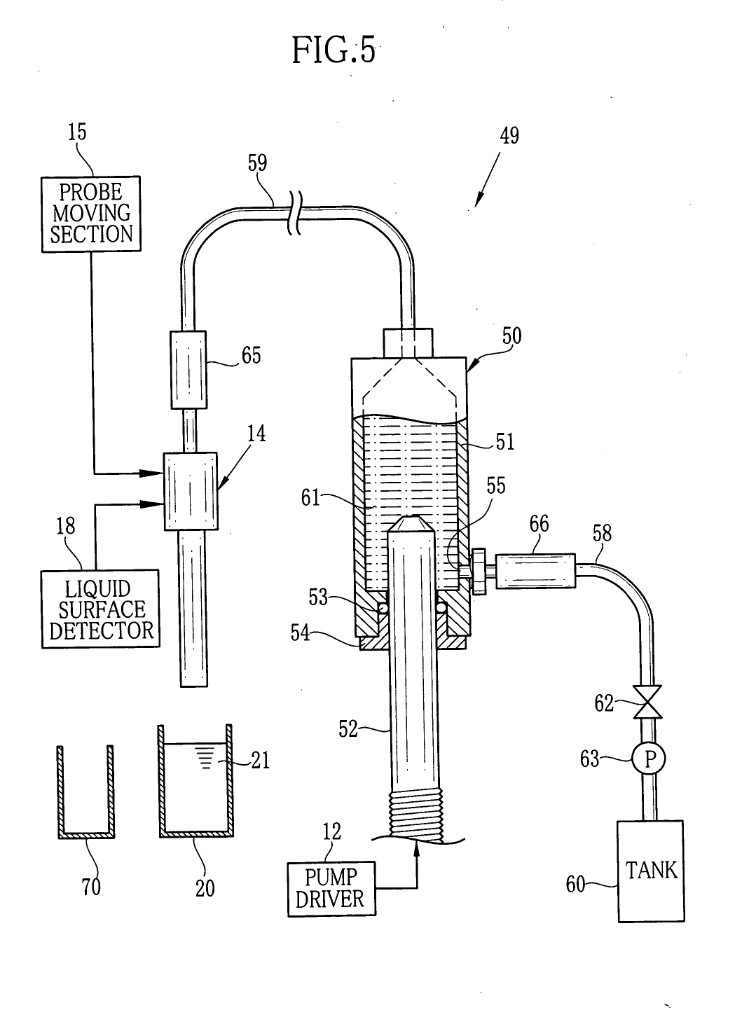

Although the above-described embodiment uses air as a pressure medium on sucking the liquid 21, the present invention is applicable to a liquid supplier that uses a liquid, like water, as a pressure medium, as shown in FIG. 5. Because liquid is less variable in volume than gas, like air, the liquid supplier using liquid as the pressure medium can control the amount of liquid more precisely on sucking and discharging it. In the second embodiment, the same or like elements are designated by the same reference numerals as the first embodiment, so that redundancies are omitted from the following description.

A syringe pump 50 is constituted of a syringe body 51, a plunger 52, an O-ring 53, an O-ring holder 54 and a pump driver 12. A water inlet 55 is formed through a portion of the syringe body 51. To the water inlet 55 is supplied water 61 from a water tank 60 through a tube 58. For this purpose, the tube 58 is provided with an electromagnetic valve 62 and a pump 63, which are arranged sequentially. The syringe pump 50 is connected through a tube 59 to a suction probe 14. If necessary, air bubble detectors 65 and 66 are disposed in liquid channels, including the tubes 58 and 59. The air bubble detectors 65 and 66 may be any devices that can detect air bubbles in the water optically or physically. When the air bubble detector 65 or 66 detects air bubbles, water is fed into the tubes 58 and 59 till the air bubbles are eliminated. Also during a dispensing process, if the air bubble detector 65 detects air bubbles in a sucked liquid 21, such as a specimen, a reagent or a diluent, the liquid containing the air bubbles is discharged, and then the liquid 21 is sucked again from a cup 20 into the suction probe 14. Thus, the liquid 21 is sucked and discharged in a condition free from air bubbles. So the accuracy of dispensing is improved.

On the dispensing process, the electromagnetic valve 62 is opened and then the pump 63 is driven to send the water from the water tank 60 through the tube 58 into the syringe pump 50. The pump 63 continues sending the water till the water is discharged from a tip of the suction probe 14. While the water is being fed into the syringe pump 50, the air bubble detectors 65 and 66 check if air bubbles are mixed in the water in the tubes 58 and 59. If any air bubbles are detected, water is fed through the tubes 58 and 59 until the air bubble detectors 65 and 66 do not detect any air bubbles. When the air bubbles are thus ejected from the tubes 58 and 59, the pump 63 stops feeding water, and is turned off. The electromagnetic valve 62 is closed. Next, the pump driver 12 drives the plunger 52 to move into the syringe body 51, to discharge the water from the suction probe 14. Thereafter, the plunger 52 is moved a little backward, to suck air into the suction probe 14 to an extent necessary for preventing mixture of the water with the liquid to suck. In this condition, the liquid supplier 49 can start sucking and dispensing the liquid 21 with high accuracy.

The cup 20 containing the liquid 21 and a reaction cup 70 are arranged side by side at predetermined spacing from each other below the suction probe 14. The liquid 21 is sucked from the cup 20, and is dispensed into the reaction cup 70. It is possible to use a test chip in place of the reaction cup 70.

It is also possible to dispose an air bubble detector in the tube 13 of the liquid supplier 10 of the first embodiment.

The liquid surface detector of the present invention is applicable not only to biochemical analyzers like in the above embodiments, but also to such analyzers that need to deal with liquids of small amounts, i.e. not more than 100 micro liters, especially 1 to 20 micro liters, including those used for micro-TAS, nucleic acid extraction and immunoassay. The present invention can also be applicable to other various fields that deal with liquids.

Thus, the present invention is not to be limited to the above embodiments but, on the contrary, various modifications will be possible without departing from the scope of claims appended hereto.

What is claimed is:

1. A liquid surface detection device comprising:
an oscillator oscillating at a first frequency to output an alternating current signal;
a modulator circuit including a conductive member that is movable up and down relative to a surface of a liquid, said modulator circuit modulating said alternating current signal from said oscillator with a capacitance index signal, said capacitance index signal indicating a change in capacitance that is caused by the movement of said conductive member relative to the liquid surface;
a first filtering circuit for filtering an output signal of said modulator, to pass a frequency component having the first frequency through it;
a wave detector circuit for detecting a signal from an output of said first filtering circuit;
a second filtering circuit for filtering the signal output from said wave detector circuit, to pass a frequency component having a second frequency through it, the second frequency being a frequency of said capacitance index signal; and
a comparator for comparing an output signal of said second filtering circuit with a reference signal to detect that said conductive member gets into contact with the liquid surface.

2. A liquid surface detection device as claimed in claim 1, wherein the first frequency of said oscillator is set to be not less than 50 times the second frequency of said capacitance index signal.

3. A liquid surface detection device as claimed in claim 1, wherein the first frequency of said oscillator is set at 100 kHz to 2000 kHz.

4. A liquid surface detection device as claimed in claim 1, further comprising a second comparator for comparing the output signal of said second filtering circuit with a second reference signal to detect that said conductive member removes off the liquid surface.

5. A liquid surface detection device as claimed in claim 1, wherein said conductive member is a probe for sucking and discharging the liquid.
